(19) United States
(12) Patent Application Publication
(10) Pub. No.: US 2026/0153827 A1
(43) Pub. Date: Jun. 4, 2026

(54) IMAGE FORMING APPARATUS, INSPECTION APPARATUS, AND INSPECTION METHOD

(71) Applicant: Konica Minolta, Inc., Tokyo (JP)

(72) Inventors: Yuyuan CHENG, Tokyo (JP); Mikihiko TAKADA, Tokyo (JP); Shunichi TAKAYA, Tokyo (JP); Yotaro SATO, Tokyo (JP); Azusa NAKAMURA, Tokyo (JP); Masayuki KADOGUCHI, Tokyo (JP)

(21) Appl. No.: 19/404,754

(22) Filed: Dec. 1, 2025

(30) Foreign Application Priority Data
Dec. 3, 2024 (JP) 2024-210663

(51) Int. Cl. G03G 15/00; G03G 9/08; G03G 15/01; G03G 15/08

(52) U.S. Cl. CPC G03G 15/55; G03G 9/0802; G03G 15/0189; G03G 15/0822; G03G 15/5029; G03G 15/6591

(57) ABSTRACT

An image forming apparatus that forms an image on a recording medium includes: a through-beam sensor that detects the recording medium on which the image has been formed; and a hardware processor that determines whether density unevenness is present, based on a detection result by the through-beam sensor. In one embodiment, the recording medium on which the image has been formed is used by being attached to an attachment-target object.

### CROSS-REFERENCE TO RELATED APPLICATIONS

The entire disclosure of Japanese Patent Application No. 2024-210663 filed on Dec. 3, 2024, is incorporated herein by reference in its entirety.

### BACKGROUND OF THE INVENTION

### Technical Field

The present disclosure relates to an image forming apparatus, an inspection apparatus, and an inspection method.

### Description of Related Art

A known image forming apparatus is configured to inspect image density, density unevenness, and so forth to maintain image quality.

For example, there is proposed an image forming apparatus that includes an image density detection means (see Japanese Unexamined Patent Publication No. 2002-14497). The image density detection means detects the amount of toner adhered to a toner image transferred to a transfer belt or a transfer member. The image density detecting means detects the image density of the toner image by transmitted light.

There is also proposed an image forming apparatus that includes density sensors (reflection-type sensors) provided in the axis direction of the intermediate transfer belt and that detects the density of a toner image that has been primarily transferred onto the intermediate transfer belt at multiple places (see Japanese Unexamined Patent Publication No. 2024-74619). This image forming apparatus determines the cause of uneven density, based on the relation between the maximum density value and the minimum density value among the detected density values.

### SUMMARY OF THE INVENTION

However, the density unevenness may not be visually recognized unless the recording medium bearing an image is placed in an environment in which the recording medium is actually used. For example, a transparent film can be used for a label to be attached to a wine bottle. If there is density unevenness in the background part of an image formed on the label, a user may only recognize the density unevenness after attaching the label to the bottle. Such problems often occur particularly when a solid white image is formed on the label.

Such density unevenness cannot be visually recognized unless a certain amount of light passes through the recording medium and the image. It has been difficult to detect such density unevenness by visual inspection or by a conventional reflection-type sensor.

Although the technology described in JP2002-14497A detects the image density of the toner image transferred to the transfer member using transmitted light, the technology is not intended to detect density unevenness.

Further, since the technology described in JP2024-74619A uses a reflection-type sensor, the technology cannot detect density unevenness on recording media that are used by being attached to attachment-target objects, such as bottles.

The present disclosure has been made in consideration of the above-described challenges in conventional technology. An object of the present disclosure is to accurately detect density unevenness on a recording medium.

To achieve at least one of the abovementioned objects, according to an aspect of the present invention, an image forming apparatus that forms an image on a recording medium includes: a through-beam sensor that detects the recording medium on which the image has been formed; and a hardware processor that determines whether density unevenness is present, based on a detection result by the through-beam sensor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 illustrates a schematic configuration of an image forming apparatus in an embodiment of the present disclosure;

FIG. 2 is an enlarged schematic diagram of a portion including through-beam sensors and a fixing section;

FIG. 3 illustrates an example of arrangement of through-beam sensors;

FIG. 4 is a block diagram of a functional configuration of the image forming apparatus;

FIG. 5 is a schematic diagram of light transmitted through a transparent bottle;

FIG. 6 is a schematic diagram of light transmitted through a colored bottle;

FIG. 7 is a diagram for explaining a printed material detection mode in which a recording medium is detected by a through-beam sensor;

FIG. 8 is a diagram for explaining an attachment-object detection mode in which an attachment-target object is detected by a through-beam sensor;

FIG. 9 illustrates an example of a toner layer in the case where a low-density image is formed on a white solid image with YMCK toner;

FIG. 10 illustrates an example of a toner layer in the case where a medium-density image is formed on a white solid image with YMCK toner;

FIG. 11 illustrates an example of a toner layer in the case where a high-density image is formed on a white solid image with YMCK toner;

FIG. 12 illustrates an example of a toner layer in the case where a white solid image (L*=77.9) is formed;

FIG. 13 illustrates an example of a toner layer in the case where a solid white image (L*=83.6) is formed;

FIG. 14 illustrates an example of a toner layer when a solid white image (L*>83.6) is formed;

FIG. 15 illustrates an example of a recording medium on which an image has been formed;

FIG. 16 is a graph showing light transmittance detected by the through-beam sensor along the line B1 and the line B2 illustrated in FIG. 15;

FIG. 17 is a diagram showing the result of examining whether density unevenness is present by changing image forming conditions;

FIG. 18 is a flowchart of a density unevenness determination process to be executed by the image forming apparatus;

FIG. 19 is a diagram for explaining a method of adjusting the through-beam sensor when a transparent sheet is used as the recording medium;

FIG. 20 illustrates an example of how light is adjusted for a through-beam sensor (wavelength: blue region, light amount: small);

FIG. 21 illustrates an example of how light is adjusted for a through-beam sensor (wavelength: red region, light amount: normal);

FIG. 22 illustrates an example of how light is adjusted for a through-beam sensor (wavelength: green region, light amount: large); and

FIG. 23 is a diagram for explaining a method of adjusting a through-beam sensor when tack paper is used as a recording medium.

### DETAILED DESCRIPTION

Hereinafter, one or more embodiments of the present invention will be described with reference to the drawings. However, the scope of the invention is not limited to the disclosed embodiments.

In the following, an embodiment of the present disclosure will be described with reference to the drawings. The advantages and features provided by the embodiment will be understood from the following detailed description and the drawings. However, the scope of the present disclosure is not limited to the embodiment disclosed below or the illustrations in the drawings.

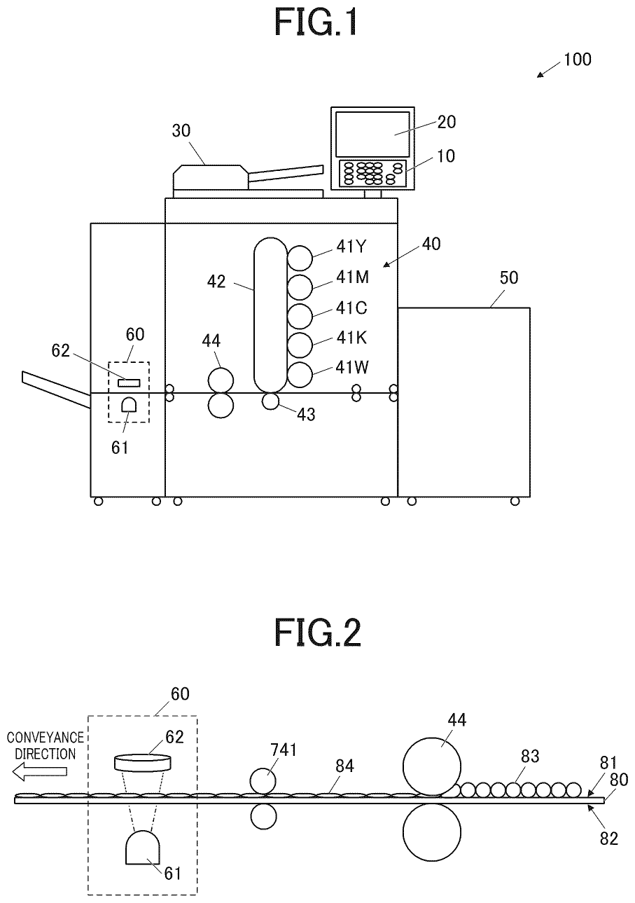

FIG. 1 illustrates a schematic configuration of an image forming apparatus 100. The image forming apparatus 100 forms an image on a recording medium by the electrophotographic method. The image forming apparatus 100 forms an image, based on image data received from an external device or image data obtained by reading an image on a document. The image forming apparatus 100 includes an operation part 10, a display part 20, a document reading unit 30, an image forming section 40, a sheet feed section 50, and a through-beam sensor(s) 60.

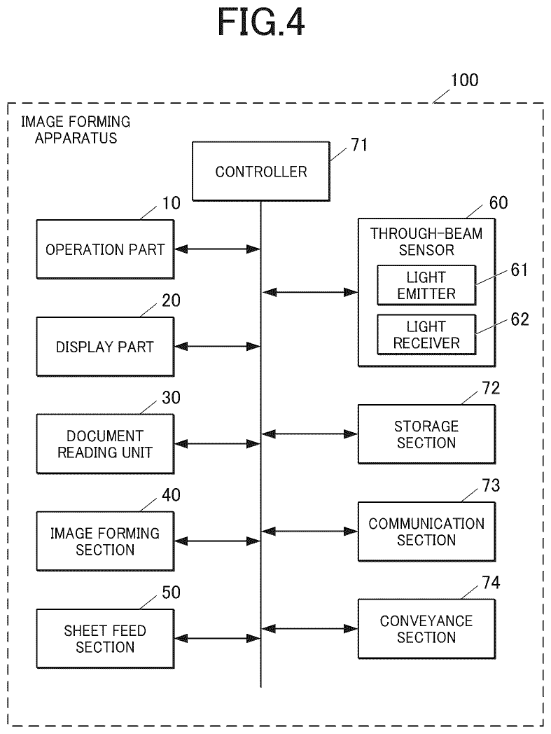

The operation part 10 receives various operations by a user and outputs operation signals based on the operations to a controller 71 (hardware processor, see FIG. 4). The operation part 10 includes a touch screen, a numeric keypad, a start button, and a stop button.

The display part 20 consists of a liquid crystal display (LCD). The display part 20 displays various screens according to instructions of display signals input by the controller 71.

The document reading unit 30 includes an automatic document feeder (ADF) and a scanner. The document reading unit 30 outputs image data obtained by reading images on documents to the controller 71.

The image forming section 40 forms images on recording media supplied by the sheet feed section 50. The image forming section 40 forms images with color materials (toner) in white (W) as a spot color in addition to normal process colors of yellow (Y), magenta (M), cyan (C), and black (K). That is, the image forming section 40 can form an image on a recording medium with multiple colors. The image forming section 40 includes photosensitive drums 41Y, 41M, 41C, 41K, and 41W corresponding to the colors of yellow, magenta, cyan, black, and white, respectively. The image forming section 40 further includes an intermediate transfer belt 42, a secondary transfer roller 43, and a fixing section 44.

For example, the image forming section 40 uniformly charges the photosensitive drum 41Y and then scans and exposes the photosensitive drum 41Y with a laser beam, based on yellow image data, thereby forming an electrostatic latent image. The image forming section 40 attaches yellow toner to the electrostatic latent image on the photosensitive drum 41Y to develop the image. Processing for the other colors is the same as the processing for yellow. The image forming section 40 sequentially transfers the toner images of the respective colors formed on the photosensitive drums 41Y, 41M, 41C, 41K, and 41 W corresponding to the respective colors onto the intermediate transfer belt 42 (primary transfer). That is, a color toner image formed by superposing the multiple-color toner images can be formed on the intermediate transfer belt 42. The image forming section 40 collectively transfers the color toner image on the intermediate transfer belt 42 onto the sheet (secondary transfer). The fixing section 44 fixes the color toner image to the recording medium by applying heat and pressure.

The sheet feed section 50 includes a sheet feed tray and supplies recording media to the image forming section 40. The sheet feed tray stores recording media of a predetermined type and size.

The through-beam sensor 60 is provided downstream of the image forming section 40 in a conveyance direction of the recording medium. The through-beam sensor 60 detects the recording medium on which an image has been formed.

FIG. 2 is an enlarged schematic diagram of a portion including the through-beam sensor 60 and the fixing section 44. The sensor 60 obtains information on the density of the image formed on the recording medium 80. Therefore, the through-beam sensor 60 is disposed at a position where the recording medium 80 after being fixed by the fixing section 44 is conveyed.

The through-beam sensor 60 includes a light emitter 61 and a light receiver 62.

The light emitter 61 includes a light source and emits light toward the light receiver 62 (recording medium 80). The light emitter 61 (emitter) emits a signal of visible light to the light receiver 62 (receiver). The wavelength and amount of light from the light emitter 61 are adjustable.

The light receiver 62 detects transmitted light transmitted through an object between the light emitter 61 and the light receiver 62. The light receiver 62 detects the light amount transmitted through the recording medium 80. The light receiver 62 outputs a signal corresponding to the light amount.

The light emitter 61 and the light receiver 62 are disposed to face each other with the recording medium 80 in-between. Herein, the light receiver 62 is arranged at the image forming surface 81 (first surface) side of the recording medium 80, and the light emitter 61 is arranged at the opposite surface 82 (second surface) side of the recording medium 80. The image forming surface 81 of the recording medium 80 is a surface on which an image has been formed. The opposite surface 82 of the recording medium 80 is a surface opposite the image forming surface 81. The arrangement of the light emitter 61 and the light receiver 62 may be the reverse of the arrangement shown in FIG. 2.

As illustrated in FIG. 2, on the upstream of the fixing section 44 in the conveyance direction of the recording medium 80, a toner layer 83 before fixing is formed on the image forming surface 81 of the recording medium 80. When the recording medium 80 passes through the fixing section 44, the image is fixed to the image forming surface 81 of the recording medium 80 (fixed image 84). The recording medium 80 is conveyed to the through-beam sensor 60 by the conveyance rollers 741.

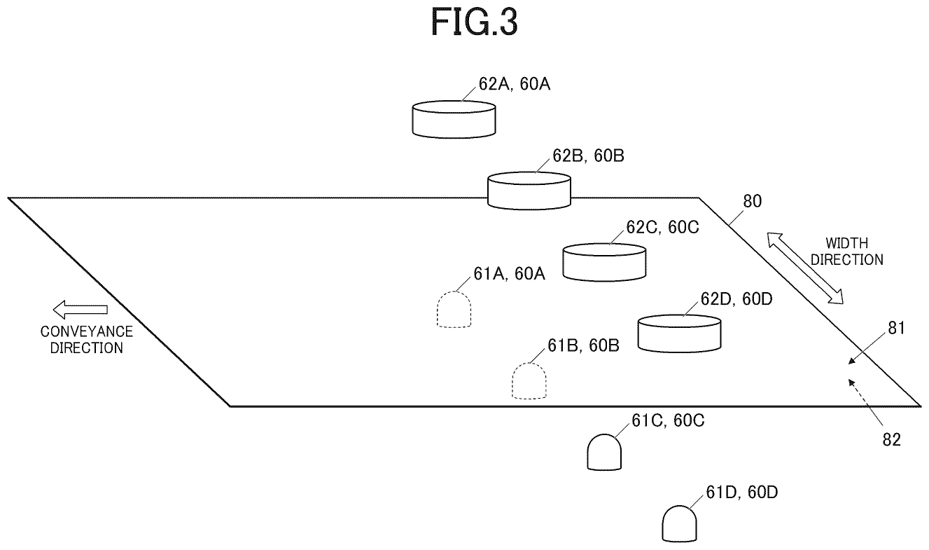

The through-beam sensors 60 are installed at multiple positions in a direction (width direction) perpendicular to the conveyance direction of the recording medium 80. FIG. 3 shows an arrangement example of through-beam sensors 60A, 60B, 60C, and 60D. In FIG. 3, the individual through-beam sensors 60 are denoted by A to D to be distinguishable from each other. The same applies to the light emitters 61 and the light receivers 62. For example, the through-beam sensor 60A includes the light emitter 61A and the light receiver 62A. The light receivers 62A, 62B, 62C, and 62D are arranged at the image forming surface 81 side of the recording medium 80, and the light emitters 61A, 61B, 61C, and 61D are arranged at the opposite surface 82 side of the recording medium 80. With the multiple through-beam sensors 60A, 60B, 60C, and 60D, the entire area of the recording medium 80 in the width direction can be detected.

Note that the through-beam sensor 60 may be installed at one position in a direction (width direction) perpendicular to the conveyance direction of the recording medium as long as the through-beam sensor 60 can detect a target area of density unevenness determination on the recording medium.

FIG. 4 is a block diagram illustrating a functional configuration of the image forming apparatus 100.

As shown in FIG. 4, the image forming apparatus 100 includes the operation part 10, the display part 20, the document reading unit 30, the image forming section 40, the sheet feed section 50, the through-beam sensor(s) 60, the controller 71, the storage section 72, the communication section 73, and the conveyance section 74. The already-described functional components are not described here.

The controller 71 includes a central processing unit (CPU) and a random access memory (RAM). The CPU reads various programs stored in the storage section 72 and loads the programs in the RAM. The CPU executes various processes in accordance with the loaded programs.

The storage section 72 is a nonvolatile storage device, such as a hard disk or a flash memory. The storage section 72 stores various programs to be executed by the controller 71 and various kinds of data necessary for execution of the programs.

The communication section 73 sends and receives data to and from an external device connected to a communication network, such as a local area network (LAN).

The conveyance section 74 includes conveyance rollers for conveying the recording medium. The conveyance section 74 conveys the recording medium in the image forming apparatus 100. The conveyance section 74 feeds the recording medium stored in the sheet feed tray of the sheet feed section 50 to the image forming section 40. The conveyance section 74 conveys the recording medium on which an image has been formed to the through-beam sensor 60 and thereafter ejects the recording medium outside the image forming apparatus 100.

The controller 71 determines the density unevenness, based on the detection result by the through-beam sensor 60.

The through-beam sensor 60 that detects the recording medium on which the image has been formed and the controller 71 constitute an inspection apparatus.

The controller 71 determines whether density unevenness is present on the recording medium, based on a change in the light amount detected by the through-beam sensor 60.

The recording medium on which the image has been formed is used by being attached to an attachment-target object. The attachment-target object is an object to which a recording medium is attached. An object having a high light transmittance is used as the attachment-target object. Examples of the object having a high light transmittance include glass (e.g., a transparent bottle, a colored bottle) and transparent resin.

The controller 71 adjusts the wavelength of the light of the through-beam sensor 60 according to the color of the attachment-target object.

The controller 71 adjusts the amount of light of the through-beam sensor 60 according to the light transmittance of the attachment-target object.

As the recording medium, an object having a high light transmittance is used. For example, the recording medium is a transparent sheet. For example, the transparent sheet is a transparent film.

As the recording medium, tack paper is used. Tack paper consists of at least a transparent sheet on which an image is formed and a release sheet (base sheet). When the tack paper is used, the transparent sheet is peeled off from the release sheet, and the transparent sheet is attached to the attachment-target object.

The controller 71 adjusts the wavelength of light of the through-beam sensor 60 according to the color of the release sheet.

The controller 71 adjusts the light amount of the through-beam sensor 60 according to the light transmittance of the release sheet.

When determining that density unevenness is present, the controller 71 notifies the operator that density unevenness is present.

When determining that density unevenness is present, the controller 71 reflects the density unevenness determination result to the image forming conditions of the image forming apparatus 100 (image forming section 40) as feedback.

Herein, changes in the appearance of light caused by the attachment-target object will be described.

FIG. 5 schematically shows light transmitted through a transparent bottle 91 when a label 85 (recording medium) is attached to the transparent bottle 91.

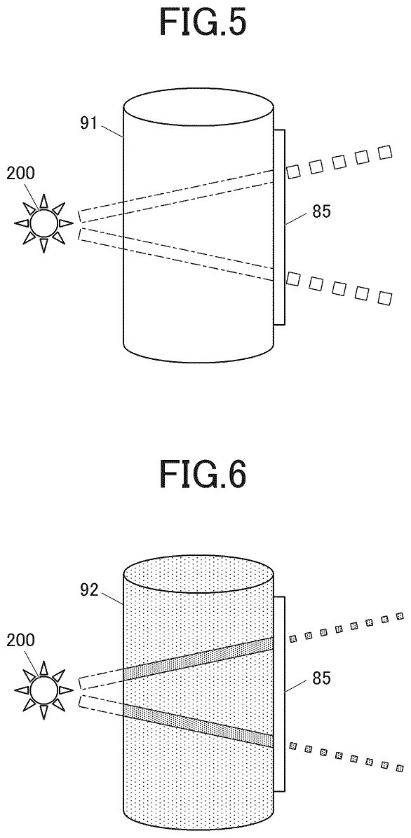

FIG. 6 schematically shows light transmitted through a colored bottle 92 when a label 85 (recording medium) is attached to the colored bottle 92. The material of the colored bottle 92 is colored glass, such as brown or blue, for example.

For the transparent bottle 91, the color of light emitted by the light source 200 does not change greatly before and after the light passes through the transparent bottle 91. Further, the light amount passing through the transparent bottle 91 is greater than the light amount passing through the colored bottle 92.

For the colored bottle 92, the color of light emitted by the light source 200 changes before and after the light passes through the colored bottle 92. The light amount passing through the colored bottle 92 is less than the light amount passing through the transparent bottle 91.

As illustrated in FIG. 5 and FIG. 6, the color (wavelength) and/or the amount of light having passed through the attachment-target object differs, depending on the attachment-target object (the transparent bottle 91 or the colored bottle 92). When the image on the label 85 has density unevenness, whether the density unevenness is visually recognizable depends on the attachment-target object. To deal with this, the feature amount of light emitted by the light emitter 61, such as the light wavelength and the light amount, is adjusted so that the density unevenness can be determined under conditions corresponding to the usage environment of the label 85 (recording medium).

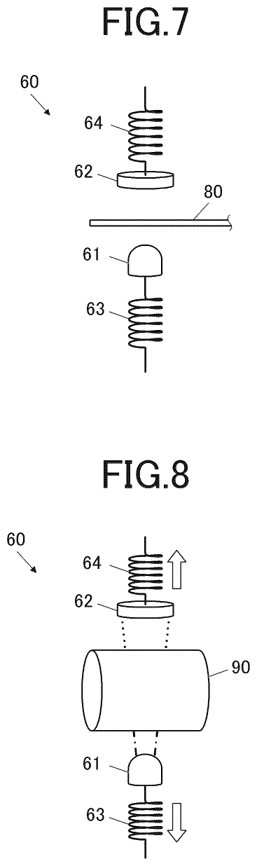

Next, a method of obtaining information on the attachment-target object with the through-beam sensor 60 will be described. The through-beam sensor 60 is configured to operate in a printed material detection mode and an attachment-target object detection mode. As illustrated in FIG. 7 and FIG. 8, the light emitter 61 and the light receiver 62 constituting the through-beam sensor 60 are provided with separation mechanisms 63 and 64, respectively. With the separation mechanisms 63 and 64, the light emitter 61 and the light receiver 62 are separated from each other. The separation mechanisms 63 and 64 are configured to adjust the distance between the light emitter 61 and the light receiver 62 and may each consist of an elastic body, such as a spring, for example.

The controller 71 controls the separation mechanisms 63 and 64 to adjust the distance between the light emitter 61 and the light receiver 62 according to the size of the detection target (recording medium or attachment-target object). For another example, the operator may manually operate the separation mechanisms 63 and 64 to adjust the distance between the light emitter 61 and the light receiver 62.

As illustrated in FIG. 7, in the printed material detection mode, the through-beam sensor 60 detects the recording medium 80. In the printed material detection mode, the distance between the light emitter 61 and the light receiver 62 is adjusted to a normal distance (distance at the time of image formation). To determine whether density unevenness is present, the through-beam sensor 60 in the printed material detection mode detects the recording medium 80 on which an image has been formed. To obtain information on the recording medium beforehand, the through-beam sensor 60 in the printed material detection mode detects the recording medium 80 on which no image is formed.

As illustrated in FIG. 8, in the attachment-target object detection mode, the through-beam sensor 60 detects the attachment-target object 90. In the attachment-target object detection mode, the separation mechanisms 63 and 64 increase the distance between the light emitter 61 and the light receiver 62 so that the attachment-target object 90 can be set between the light emitter 61 and the light receiver 62.

Next, the method of determining whether density unevenness is present will be described.

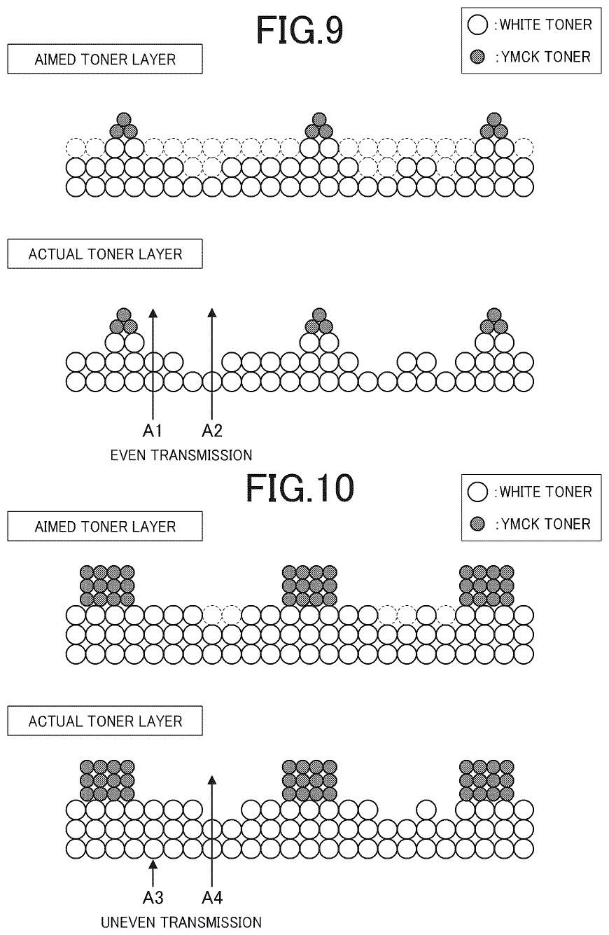

FIG. 9 illustrates an example of a toner layer when a low-density image is formed with YMCK toner on a white solid image. The white solid image is formed with white toner and has uniform density. In FIG. 9, illustration of the recording medium is omitted. The upper diagram in FIG. 9 illustrates an aimed toner layer. The lower diagram in FIG. 9 illustrates an actually formed toner layer. The toner depicted with a broken line in the upper diagram in FIG. 9 is the toner that has not been transferred in the lower diagram in FIG. 9. The same depiction method applies to FIG. 10 to FIG. 14.

The amount of transmitted light changes according to the toner layer formed on the recording medium. The changes in the amount of transmitted light can cause transmission unevenness. For example, when toner is transferred insufficiently or excessively, the toner layer changes even in the area having the white solid image only.

In FIG. 9, light passes through the toner layer at the measurement points A1 and A2. When the white toner layer has different thicknesses but the difference in thickness does not greatly affect light transmittance, the transmission unevenness is not visually recognized.

FIG. 10 illustrates an example of a toner layer when a medium-density image is formed with YMCK toner on a white solid image. In FIG. 10, light is not transmitted at the measurement point A3 but is transmitted at the measurement point A4. When the difference in thickness of the white toner layer greatly affects light transmittance, the transmission unevenness tends to be visually recognized.

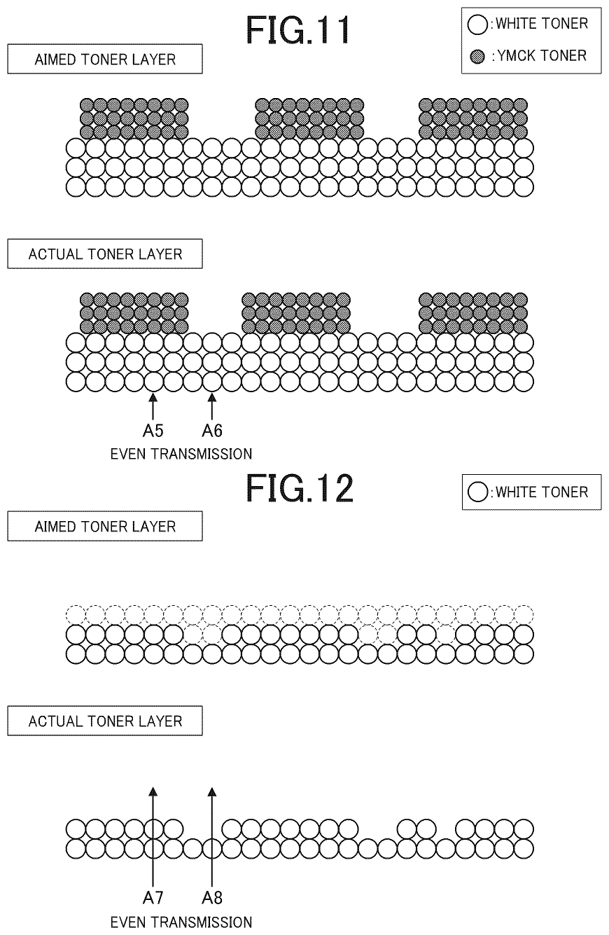

FIG. 11 illustrates an example of a toner layer when a high-density image is formed with YMCK toner on a white solid image. In FIG. 11, light is not transmitted at the measurement points A5 and A6. When the toner layer including YMCK toner has different thicknesses but the difference in thickness does not greatly affect light transmittance, the transmission unevenness is not visually recognized.

FIG. 12 illustrates an example of a toner layer when a white solid image (L*=77.9) is formed. In FIG. 12, light is transmitted at the measurement points A7 and A8. When the white toner layer has different thicknesses but the difference in thickness does not greatly affect light transmittance, the transmission unevenness is not visually recognized.

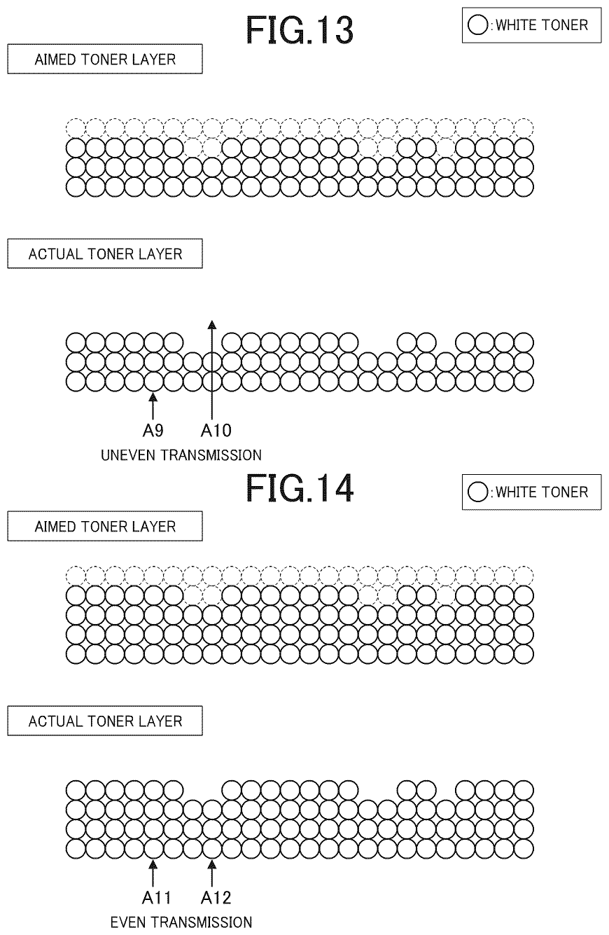

FIG. 13 illustrates an example of a toner layer when a solid white image (L*=83.6) is formed. In FIG. 13, light is not transmitted at the measurement point A9 but is transmitted at the measurement point A10. When the difference in thickness of the white toner layer greatly affects light transmittance, the transmission unevenness tends to be visually recognized.

FIG. 14 illustrates an example of a toner layer when a solid white image (L*>83.6) is formed. In FIG. 14, light is not transmitted at the measurement points A11 and A12. When the white toner layer has different thicknesses but the difference in thickness does not greatly affect light transmittance, the transmission unevenness is not visually recognized.

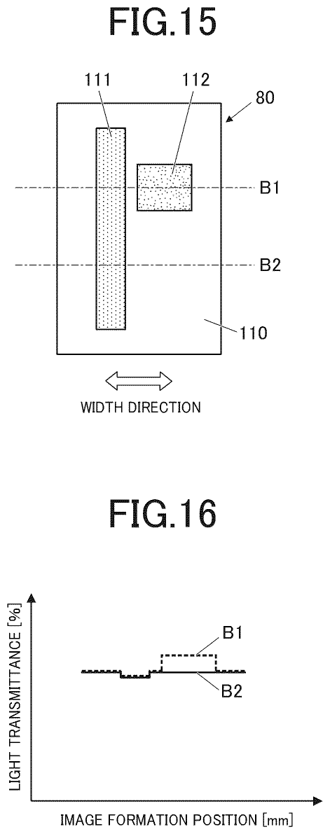

FIG. 15 is an example of the recording medium 80 on which an image has been formed. A white solid image 110 has been formed on the entire surface of the recording medium 80, and a color image with YMCK toner has been formed in an area 111 on the white solid image. The white solid image has density unevenness in an area 112.

FIG. 16 is a graph showing light transmittance of the recording medium 80 detected by the through-beam sensor 60 along the lines B1 and B2 in FIG. 15. The horizontal axis represents positions on the recording medium 80 in the width direction.

Referring to the graph of the light transmittance along the line B2, the light transmittance at the area 111 is lower than the light transmittance at the surrounding white solid image 110.

Referring to the graph of the light transmittance along the line B1, the light transmittance at the area 111 is also lower than the light transmittance at the surrounding white solid image 110. Further, referring to the graph of the light transmittance along the line B1, the light transmittance at the area 112 is higher than at the surrounding white solid image 110. This is considered to be caused by an insufficient amount of white toner in the area 112.

In the present embodiment, the controller 71 determines whether density unevenness is present, based on a change in light transmittance. Specifically, when a change in light transmittance is equal to or greater than a reference value (e.g., 2%) in an area having the same (uniform) number of toner layers, the controller 71 determines that density unevenness occurs. Having the same (uniform) number of toner layers means that the area has the same (uniform) number of toner layers constituting an image. Ideally, in the area having the same number of toner layers, the image has a uniform thickness. For example, the area having the same number of toner layers is an area having the same combination of Y, M, C, K, and W in pixel values of image data. The change in light transmittance is a difference between the maximum value and the minimum value of light transmittance detected in a target area. The reference value (threshold value) for determining density unevenness is determined, based on the light transmittance of the attachment-target object (e.g., bottle), for example.

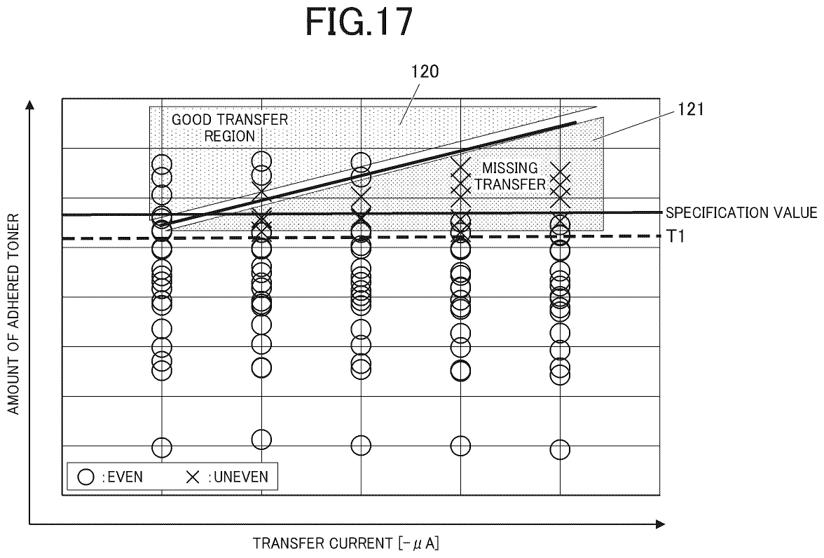

FIG. 17 shows the results of an experiment in which occurrence of density unevenness was examined under various image forming conditions. In this experiment, white solid images were formed with different transfer currents and different toner adhesion amounts as the image forming conditions, and the density unevenness of the white solid images was visually checked. The transfer current is a current for transferring the toner image from the intermediate transfer belt 42 onto the recording medium. The toner adhesion amount is the amount of toner adhered to the recording medium.

When a combination of the transfer current and the toner adhesion amount was in the area 120 in FIG. 17, the transfer was satisfactory, and the density unevenness did not occur.

When a combination of the transfer current and the toner adhesion amount was in the area 121 in FIG. 17, the transferred image was partially missing, and the density unevenness was visually recognized.

Under the conditions in which the toner adhesion amount was less than the predetermined value T1 (low density), the density unevenness was not visually recognized.

The image forming conditions under which density unevenness is likely to occur may be recorded in a database, and the information in the database may be used for determining density unevenness. For example, when performing printing under image forming conditions under which density unevenness is likely to occur, the controller 71 determines density unevenness with stricter determination criteria. Image forming conditions can vary depending on the paper type, environment, and changes in physical properties due to usage of a member, for example.

The physical property values of toner used by the image forming apparatus 100 have the following characteristics.

The particle diameter of white toner is greater than the particle diameter of YMCK toner (color toner). For example, the average particle diameter of white toner (special color toner) is greater than the average particle diameter of YMCK toner by 1 μm or more. This numerical value (boundary value) was determined, based on the particle diameter of toner used by the model in which density unevenness actually occurred among the products of the applicant. When the particle diameter of toner is large, a gap is formed between the toner particles. Therefore, the color toner particles tend to enter the gaps in the white toner layer, and density unevenness is likely to occur.

The circularity of white toner is less than the circularity of YMCK toner. For example, the circularity of white toner (special color toner) is less than the circularity of YMCK toner by 2% or more. In other words, when the circularities of white toner and YMCK toner are expressed in percentage, a value obtained by subtracting the circularity of white toner from the circularity of YMCK toner is 2% or more. This numerical value (boundary value) was determined, based on the circularity of toner used by the model in which density unevenness actually occurred among the products of the applicant. When the circularity of toner is small (a toner particle has a complicated shape), a gap is formed between the toner particles. Therefore, the color toner particles tend to enter the gaps in the white toner layer, and density unevenness is likely to occur.

The specific gravity of white toner is greater than the specific gravity of YMCK toner. For example, the specific gravity of white toner (special color toner) is 1.3 times or more the specific gravity of YMCK toner. This numerical value (boundary value) was determined, based on the specific gravity of toner used by the model in which density unevenness actually occurred among the products of the applicant. When the specific gravity of toner is large, the toner does not easily adhere to the recording medium. Therefore, the white toner is less likely to be transferred onto the recording medium and is likely to scatter. As a result, density unevenness tends to occur.

The charge amount per unit mass (Q/M) of white toner is less than the charge amount per unit mass of YMCK toner. For example, the average charge amount of white toner (special color toner) per unit mass is 0.8 times or less the average charge amount of YMCK toner per unit mass. This numerical value (boundary value) was determined, based on the charge amount per unit mass of toner used by the model in which density unevenness occurred among the products of the applicant. When the average charge amount of white toner (special color toner) per unit mass is 0.8 times or less the average charge amount of YMCK toner per unit mass, unevenness not observed in reflection becomes conspicuous and distinguishable in transmission.

The white toner (special color toner) is produced by a pulverization method, whereas the YMCK toner is produced by a polymerization method. The toner produced by the pulverization method is more likely to have a gap between toner particles and is less likely to adhere to the recording medium than the toner produced by the polymerization method. As a result, density unevenness tends to occur.

As described above, density unevenness is likely to occur in image formation using white toner.

The controller 71 may determine whether density unevenness occurs only in an area that tends to have density unevenness. For example, based on the image data related to image formation, the controller 71 may determine an area of continuous white solid images as the density unevenness determination target. The solid white image may not be formed on the entire surface of the recording medium but may be formed on part of the recording medium. Whether density unevenness occurs may be determined when an image is formed with YMCK toner on a white solid image.

Owing to the above differences in physical property values of toner, white toner and YMCK toner have different ranges of appropriate image forming conditions. For example, assume that a necessary transfer voltage is applied to transfer a multilayer toner image, in which toners of respective colors are superposed, onto the recording medium. In such a case, a single-layer YMCK toner image may not have density unevenness, whereas a single-layer white toner image may have density unevenness.

Next, operations of the image forming apparatuses 100 will be described.

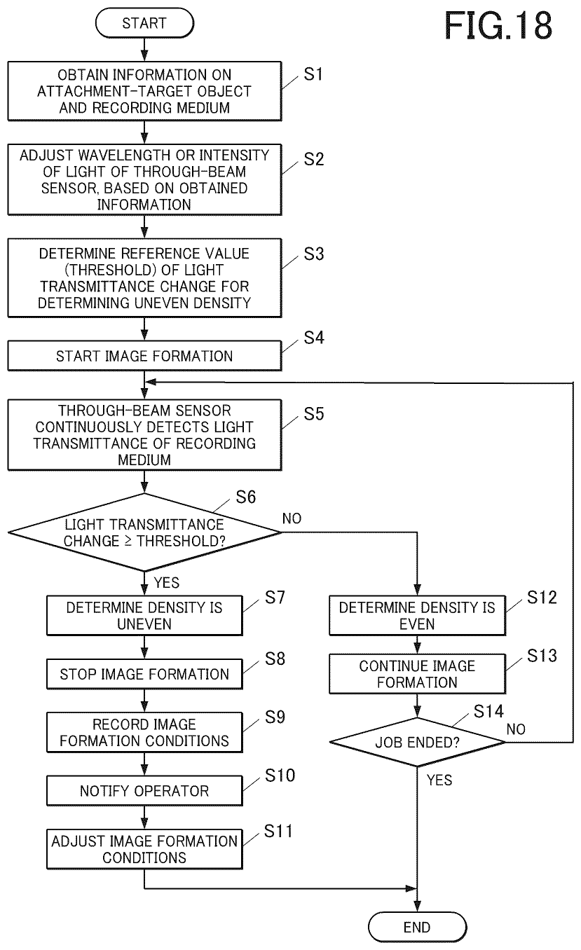

FIG. 18 is a flowchart of a density unevenness determination process to be executed by the image forming apparatus 100. This process is executed by software processing of the CPU of the controller 71 in cooperation with the program stored in the storage section 72.

First, the controller 71 obtains information on the attachment-target object and the recording medium (step S1).

Specifically, before starting image formation, the controller 71 causes the through-beam sensor 60 to detect the attachment-target object in the attachment-target object detection mode and obtains the color and light transmittance of the attachment-target object. The controller 71 controls the separation mechanisms 63 and 64 to adjust the distance between the light emitter 61 and the light receiver 62 to the distance corresponding to the attachment-target object detection mode. The operator opens the front door of the image forming apparatus 100 and sets the attachment-target object between the light emitter 61 and the light receiver 62, for example. The through-beam sensor 60 obtains information on the attachment-target object, such as the color and light transmittance. The controller 71 obtains the detection result of the attachment-target object from the through-beam sensor 60. After detecting the attachment-target object, the controller 71 may automatically return the distance between the light emitter 61 and the light receiver 62 to the distance corresponding to the printed material detection mode.

In the printed material detection mode, the controller 71 causes the through-beam sensor 60 to detect the recording medium and obtains the color and light transmittance of the recording medium. At this time, the controller 71 causes the sheet feed section 50 to supply a sheet of recording medium and causes the conveyance section 74 to convey the recording medium to the through-beam sensor 60.

Next, the controller 71 adjusts the wavelength or the amount of light of the light emitter 61 constituting the through-beam sensor 60 according to the obtained information (e.g., the color and light transmittance of the attachment-target object, the color and light transmittance of the recording medium) (step S2).

Specifically, the controller 71 adjusts the wavelength of light emitted by the light emitter 61 according to the color of the attachment-target object. Further, the controller 71 adjusts the amount (intensity) of light emitted by the light emitter 61 according to the light transmittance of the attachment-target object.

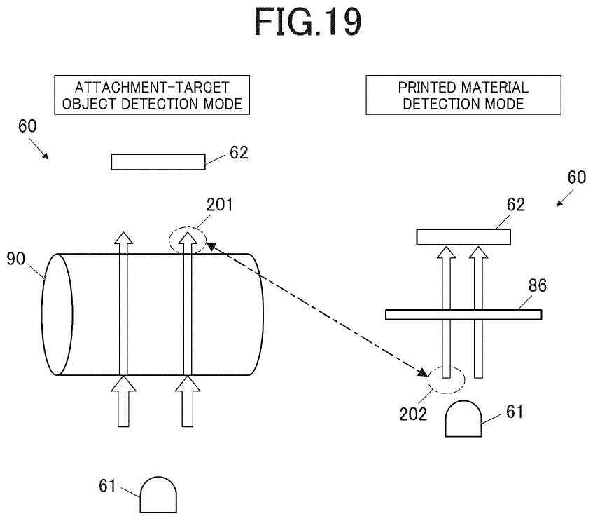

Herein, a method of adjusting the through-beam sensor 60 when the recording medium is a transparent sheet 86 is described, with reference to FIG. 19. It is assumed that, in the attachment-target object detection mode in step S1, the color and light transmittance of light 201 transmitted through the attachment-target object 90 have been detected by the through-beam sensor 60 under conditions equivalent to daylight.

The controller 71 adjusts the wavelength and amount of the light 202 emitted by the light emitter 61 to the wavelength and amount of the light 201 detected in the attachment-target object detection mode. Accordingly, the light 202 emitted by the light emitter 61 is equivalent to the light having been transmitted through the attachment-target object 90 under the daylight environment.

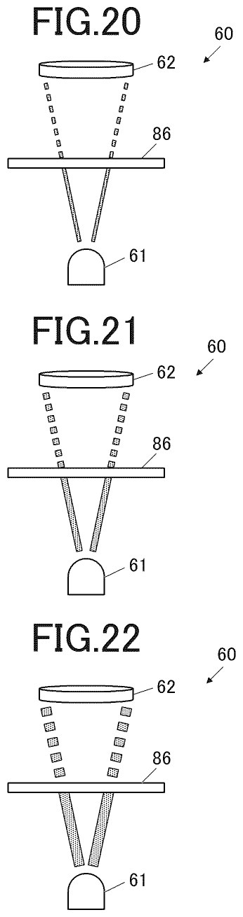

FIG. 20 to FIG. 22 illustrate an example of how to adjust light of the through-beam sensor 60. In FIG. 20 to FIG. 22, the transparent sheet 86 is used as the recording medium.

In the example of FIG. 20, the light emitter 61 emits light having the wavelength in the blue region and having a small light amount (the light intensity is weak).

In the example of FIG. 21, the light emitter 61 emits light having the wavelength in the red region and having a normal light amount (the light intensity is normal).

In the example of FIG. 22, the light emitter 61 emits light having the wavelength in the green region and having a large light amount (the light intensity is high).

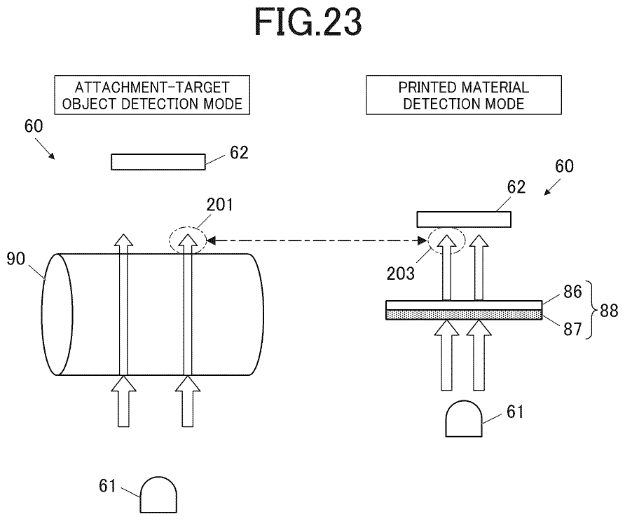

Following is a description of a method of adjusting the through-beam sensor 60 when the tack paper 88, which consists of the transparent sheet 86 and the release sheet 87, is used as the recording medium, with reference to FIG. 23. It is assumed that, in the attachment-target object detection mode in step S1, the color and light transmittance of light 201 transmitted through the attachment-target object 90 have been detected by the through-beam sensor 60 under conditions equivalent to daylight.

Due to the presence of the release sheet 87, the wavelength and amount of light transmitted through the tack paper 88 are changed, and the density unevenness is less detectable. To deal with this, the controller 71 adjusts the wavelength and amount of light of the light emitter 61 such that the wavelength and amount of the light 203 transmitted through the tack paper 88 including the release sheet 87 are equal to the wavelength and amount of the light 201 detected in the attachment-target object detection mode. The information on the tack paper 88 before image formation has been obtained in step S1 as the information on the recording medium.

The measurement is performed in the state where the release sheet 87 includes the transparent sheet 86. The presence of the transparent sheet 86 can be ignored with respect to the light color and light transmittance. It can be said that the color and light transmittance obtained with the tack paper 88 are substantially the color and the light transmittance of the release sheet 87.

Next, the controller 71 determines the reference value (threshold value) of changes in light transmittance for determining density unevenness (step S3). For example, the controller 71 determines the threshold value, based on the color of the attachment-target object, the light transmittance of the attachment-target object, the color of the recording medium, and the light transmittance of the recording medium. The controller 71 may determine the threshold value using a table in which combinations of various conditions are associated with threshold values. For another example, the controller 71 may determine the threshold value, based on various conditions and a predetermined algorithm.

Next, the controller 71 controls the image forming section 40 to start image formation (step S4). The controller 71 forms an image on the recording medium on the basis of the image data.

Next, the controller 71 causes the through-beam sensor 60 to continuously detect the light transmittance of the recording medium on which the image has been formed (step S5).

Next, for each area having the same number of toner layers, the controller 71 determines whether the change in light transmittance is greater than or equal to the threshold value (step S6). The threshold value is determined in step S3. A suitable threshold value may be determined for each area having the same number of toner layers.

When the change in light transmittance is greater than or equal to the threshold value (step S6: YES), the controller 71 determines that density unevenness occurs (step S7).

The controller 71 causes the image forming section 40 to stop image formation (step S8). The controller 71 ejects the recording medium determined to have density unevenness to a sheet ejection tray different from a tray for normal recording media.

Next, the controller 71 records the image forming conditions at the time of determining that density unevenness has occurred (step S9). The controller 71 stores information on the toner adhesion amount of each color and the transfer current in the storage section 72.

Next, the controller 71 notifies the operator that density unevenness has occurred (step S10). For example, the controller 71 causes the display part 20 to display that density unevenness has occurred. Further, the controller 71 may notify the occurrence of density unevenness by outputting sound or lighting a warning lamp, for example. The controller 71 causes the display part 20 to display the image forming conditions recorded in step S9 and the recommended conditions registered beforehand in the database.

Next, the controller 71 adjusts the image forming conditions related to density unevenness (step S11). Specifically, the controller 71 displays a screen for adjusting the image forming conditions related to density unevenness on the display part 20. The controller 71 receives input adjusted values of the image forming conditions related to density unevenness. The operator inputs various adjusted values by operating the operation part 10. Based on the input adjusted values, the controller 71 changes the image forming conditions.

The controller 71 may automatically adjust the image forming conditions related to density unevenness. Based on the determination result of density unevenness and the degree of density unevenness, the controller 71 calculates image forming conditions for the image forming section 40 to eliminate density unevenness. For example, the controller 71 adjusts the toner adhesion amount and the transfer current to values in the area 120 of FIG. 17.

For another example, the controller 71 may control the image forming section 40 to form images on the recording medium under multiple sets of conditions in the area 120 of FIG. 17, cause the through-beam sensor 60 to measure the light transmittance, and find out the optimum conditions. The controller 71 may automatically adopt the optimal conditions. The controller 71 may display the optimal conditions on the display part 20, obtain confirmation from the operator, and perform adjustment of the conditions.

In step S6, when the change in light transmittance is less than the threshold value (step S6: NO), the controller 71 determines that no density unevenness occurs (step S12).

The controller 71 continues image formation with the image forming section 40 (step S13).

The controller 71 determines whether the job has been completed (step S14).

If the job has not been completed yet (step S14: NO), the controller 71 returns to step S5.

When the job has been completed (step S14: YES) or after step S11, the density unevenness determination process ends.

As described above, according to the present embodiment, the controller 71 of the image forming apparatus 100 determines density unevenness, based on the detection result by the through-beam sensor 60. Since the through-beam sensor 60 detects the recording medium by transmitting light, the controller 71 can accurately detect density unevenness on the recording medium.

The controller 71 determines whether density unevenness is present on the recording medium, based on a change in the light amount detected by the through-beam sensor 60. Thus, the controller 71 can accurately detect density unevenness, based on unevenness in the light amount transmitted through the recording medium.

Further, the through-beam sensors 60 are provided at multiple positions in a direction (width direction) perpendicular to the conveyance direction of the recording medium. Therefore, the controller 71 can detect density unevenness on the recording medium over the width direction of the recording medium.

Conventionally, density unevenness cannot be detected beforehand for a recording medium that is used by being attached to an attachment-target object (e.g., a bottle). According to the present embodiment, density unevenness can be detected before the recording medium is attached to the attachment-target object. Specifically, the controller 71 can obtain the characteristics of the attachment-target object to which the recording medium is to be attached beforehand, and determine density unevenness under conditions similar to actual usage conditions. The present embodiment is particularly effective when the attachment-target object has a high light transmittance.

For example, the controller 71 adjusts the wavelength of light of the through-beam sensor 60 according to the color of the attachment-target object. Since the controller 71 adjusts the color of light emitted by the light emitter 61 to be closer to the color of light transmitted through the attachment-target object, the controller 71 can detect density unevenness in a state closer to the environment in which the recording medium is used.

The controller 71 adjusts the amount of light of the through-beam sensor 60 according to the light transmittance of the attachment-target object. Since the controller 71 adjusts the amount of light emitted by the light emitter 61 to be closer to the amount of light transmitted through the attachment-target object, the controller 71 can detect density unevenness in a state closer to the environment in which the recording medium is used.

The determination of density unevenness using the through-beam sensor 60 is particularly effective when the recording medium is an object having a high light transmittance (e.g., a transparent sheet).

The controller 71 can accurately detect density unevenness on the recording medium even when the recording medium is tack paper, which consists of at least a transparent sheet on which an image is formed and a release sheet adhered to each other.

For example, the controller 71 adjusts the wavelength of light from the through-beam sensor 60 according to the color of the release sheet (tack paper). Since the controller 71 adjusts the color of light emitted by the through-beam sensor 60 and transmitted through the tack paper to be closer to the color of light transmitted through the attachment-target object, the controller 71 can detect density unevenness in a state closer to the environment in which the recording medium is used.

The controller 71 adjusts the amount of light of the through-beam sensor 60 according to the light transmittance of the release sheet (tack paper). Since the controller 71 adjusts the amount of light emitted by the through-beam sensor 60 and transmitted through the tack paper to be closer to the amount of light transmitted through the attachment-target object, the controller 71 can detect density unevenness in a state closer to the environment in which the recording medium is used.

When determining that density unevenness is present, the controller 71 notifies the operator that density unevenness is present. Thus, the controller 71 can provide quality information on the image formed on the recording medium.

When determining that density unevenness is present, the controller 71 reflects the density unevenness determination result to the image forming conditions of the image forming apparatus 100 (image forming section 40) as feedback. Thus, the controller 71 can immediately correct the image forming conditions when density unevenness occurs. Accordingly, the controller 71 eliminates density unevenness and reduces defective products.

When determining that density unevenness is present, the controller 71 controls the image forming section 40 to stop image formation. Thus, defective products can be minimized.

In step S1 of the density unevenness determination process (FIG. 18), the through-beam sensor 60 for detecting the recording medium is used to detect the attachment-target object inside the image forming apparatus 100. When the attachment-target object is large and cannot be put inside the image forming apparatus 100, the color and the light transmittance of the attachment-target object may be detected by an external through-beam sensor.

In step S1 of the density unevenness determination process, the through-beam sensor 60 is used to obtain information on the attachment-target object. For another example, the controller 71 may display samples having various levels of colors and brightness on the display part 20 and allow the operator to select a sample having a color and brightness similar to those of the attachment-target object. Thus, the controller 71 may obtain the color and light transmittance of the attachment-target object.

In step S2 of the density unevenness determination process, the wavelength or the amount of light of the through-beam sensor 60 are adjusted by adjusting the wavelength or the amount of light emitted by the light emitter 61. A different method may be used. For example, filters having different levels of colors or brightness may be prepared; and a filter that makes the light of the through-beam sensor 60 closer to the light transmitted through the attachment-target object may be inserted between the light emitter 61 of the through-beam sensor 60 and the recording medium.

The above-described embodiment is an example of the image forming apparatus, the inspection apparatus, the inspection method, and the program according to the present disclosure and is not intended to limit the present disclosure. The detailed configuration and operations of each component constituting the apparatus can be appropriately changed without departing from the scope of the present disclosure.

Although white toner is used as the special color toner in the above embodiment, the special color toner may have any other color. Further, the toner used by the image forming section 40 may not include the special color toner.

The computer-readable medium that stores the program for executing each process is not limited to the above-described example. Further, a carrier wave may be applied as a medium that provides data of the program via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that forms an image on a recording medium, comprising:
a through-beam sensor that detects the recording medium on which the image has been formed; and
a hardware processor that determines whether density unevenness is present, based on a detection result by the through-beam sensor.

2. The image forming apparatus according to claim 1, wherein:
the recording medium on which the image has been formed is used by being attached to an attachment-target object, and
the hardware processor adjusts a wavelength of light of the through-beam sensor according to a color of the attachment-target object.

3. The image forming apparatus according to claim 1, wherein:
the recording medium on which the image has been formed is used by being attached to an attachment-target object, and
the hardware processor adjusts an amount of light of the through-beam sensor according to light transmittance of the attachment-target object.

4. The image forming apparatus according to claim 1, wherein:
the through-beam sensor detects an amount of light transmitted through the recording medium, and
the hardware processor determines whether density unevenness is present on the recording medium, based on a change in the amount of light detected by the through-beam sensor.

5. The image forming apparatus according to claim 1, wherein:
the through-beam sensor is provided at one or more positions in a direction perpendicular to a conveyance direction of the recording medium,
the through-beam sensor includes a light emitter that has a light source and a light receiver that detects transmitted light, and
the light emitter and the light receiver, which constitute a pair, are positioned at a first surface side on which the image has been formed and a second surface side opposite the first surface side of the recording medium so as to face each other with the recording medium in-between.

6. The image forming apparatus according to claim 1, wherein the recording medium is a transparent sheet.

7. The image forming apparatus according to claim 1, wherein the recording medium consists of at least a transparent sheet on which an image is formed and a release sheet, the transparent sheet and the release sheet being adhered to each other.

8. The image forming apparatus according to claim 7, wherein the hardware processor adjusts a wavelength of light of the through-beam sensor according to a color of the release sheet.

9. The image forming apparatus according to claim 7, wherein the hardware processor adjusts an amount of light of the through-beam sensor according to light transmittance of the release sheet.

10. The image forming apparatus according to claim 1, wherein when determining that density unevenness is present, the hardware processor notifies an operator that the density unevenness is present.

11. The image forming apparatus according to claim 1, wherein when determining that density unevenness is present, the hardware processor reflects the determination result of the density unevenness to an image forming condition of the image forming apparatus as feedback.

12. The image forming apparatus according to claim 1, wherein:
the image forming apparatus forms a toner image using YMCK toner and special color toner, and
an average particle diameter of the special color toner is greater than an average particle diameter of the YMCK toner by 1 μm or more.

13. The image forming apparatus according to claim 1, wherein:
the image forming apparatus forms a toner image using YMCK toner and special color toner, and a circularity of the special color toner is less than a circularity of the YMCK toner by 2% or more.

14. The image forming apparatus according to claim 1, wherein:
the image forming apparatus forms a toner image using YMCK toner and special color toner, and a specific gravity of the special color toner is 1.3 times or more a specific gravity of the YMCK toner.

15. The image forming apparatus according to claim 1, wherein:
the image forming apparatus forms a toner image using YMCK toner and special color toner, and
an average charge amount per unit mass of the special color toner is 0.8 times or less an average charge amount per unit mass of the YMCK toner.

16. The image forming apparatus according to claim 1, wherein:
the image forming apparatus forms a toner image using YMCK toner and special color toner, the special color toner is produced by a pulverization method, and the YMCK toner is produced by a polymerization method.

17. The image forming apparatus according to claim 12, wherein the special color toner is white toner.

18. An inspection apparatus comprising:
a through-beam sensor that detects a recording medium on which an image has been formed; and
a hardware processor that determines whether density unevenness is present, based on a detection result by the through-beam sensor.

19. An inspection method comprising:
detecting, by a through-beam sensor, a recording medium on which an image has been formed; and
determining, by a hardware processor, whether density unevenness is present, based on a detection result by the through-beam sensor.
